(19) United States
(12) Patent Application Publication
(10) Pub. No.: US 2003/0008193 A1
(43) Pub. Date: Jan. 9, 2003

(54) Liquid fuel delivery system for fuel cells

(75) Inventors: Mark R. Kinkelaar, Glenmoore, PA (US); Andrew M. Thompson, West Chester, PA (US)

Correspondence Address: ARENT FOX KINTNER PLOTKIN & KAHN, 1050 CONNECTICUT AVENUE, N.W., SUITE 400, WASHINGTON, DC, 20036, US

(73) Assignee: Foamex L.P.

(21) Appl. No.: 09/894,939

(22) Filed: Jun. 28, 2001

(51) Int. Cl. H01M 8/04

(52) U.S. Cl. 429/39

(57) ABSTRACT

A fuel delivery system for a liquid fuel cell particularly useful for portable electronic devices includes (a) a container defining a volume for holding a liquid fuel; (b) a reservoir structure positioned within the volume and into which at least a portion of the liquid fuel wicks and from which said liquid fuel subsequently may be metered, such as by pumping. The reservoir structure is formed from a material with a free rise wick height greater than at least one half of the longest dimension of the reservoir structure. Among materials with such wicking capability are foams, bundled fibers and nonwoven fibers, including particularly felted and unfelted reticulated polyurethane foams. The container may have a generally flat and thin profile, formed as a pouch or envelope with substantially planar top and bottom faces of flexible film material, such that the container holding the reservoir structure and filled with liquid fuel can be bent or shaped.

This invention relates to liquid fuel cells in which the liquid fuel is directly oxidized at the anode. In particular, it relates to the reservoir for holding and metering or delivering the liquid fuel to the anode of a liquid fuel cell. This invention also relates to liquid fuel feed systems for micro fuel cell reformers.

### BACKGROUND OF THE INVENTION

Electrochemical fuel cells convert reactants, namely fuel and oxidants, to generate electric power and reaction products. Electrochemical fuel cells generally employ an electrolyte disposed between two electrodes (an anode and a cathode). An electrocatalyst is needed to induce the desired electrochemical reactions at the electrodes. Liquid feed solid polymer fuel cells operate in a temperature range of from about 0° C. to the boiling point of the fuel, i.e., for methanol about 65° C., and are particularly preferred for portable applications. Solid polymer fuel cells include a membrane electrode assembly (“MEA”), which comprises a solid polymer electrolyte or proton-exchange membrane, sometimes abbreviated “PEM”, disposed between two electrode layers. Flow field plates for directing the reactants across one surface of each electrode are generally disposed on each side of the membrane electrode assembly. These plates may also be called the anode backing and cathode backing.

A broad range of reactants have been contemplated for use in solid polymer fuel cells, and such reactants may be delivered in gaseous or liquid streams. The oxidant stream may be substantially pure oxygen gas, but preferably a dilute oxygen stream such as found in air, is used. The fuel stream may be substantially pure hydrogen gas, or a liquid organic fuel mixture. A fuel cell operating with a liquid fuel stream wherein the fuel is reacted electrochemically at the anode (directly oxidized) is known as a direct liquid feed fuel cell.

A direct methanol fuel cell (“DMFC”) is one type of direct liquid feed fuel cell in which the fuel (liquid methanol) is directly oxidized at the anode. The following reactions occur:

Anode: CH₃OH+H₂O→6H⁺+CO₂+6e⁻

Cathode: 1.5O₂+6H⁺+6e⁻→3H₂O

The hydrogen ions (H⁺) pass through the membrane and combine with oxygen and electrons on the cathode side producing water. Electrons (e⁻) cannot pass through the membrane, and therefore flow from the anode to the cathode through an external circuit driving an electric load that consumes the power generated by the cell. The products of the reactions at the anode and cathode are carbon dioxide (CO₂) and water (H₂O), respectively. The open circuit voltage from a single cell is about 0.7 volts. Several direct methanol fuel cells are stacked in series to obtain greater voltage.

Other liquid fuels may be used in direct liquid fuel cells besides methanol—i.e., other simple alcohols, such as ethanol, or dimethoxymethane, trimethoxymethane and formic acid. Further, the oxidant may be provided in the form of an organic fluid having a high oxygen concentration—i.e., a hydrogen peroxide solution.

A direct methanol fuel cell may be operated on aqueous methanol vapor, but most commonly a liquid feed of a diluted aqueous methanol fuel solution is used. It is important to maintain separation between the anode and the cathode to prevent fuel from directly contacting the cathode and oxidizing thereon (called “cross-over”). Cross-over results in a short circuit in the cell since the electrons resulting from the oxidation reaction do not follow the current path between the electrodes. To reduce the potential for cross-over of methanol fuel from the anode to the cathode side through the MEA, very dilute solutions of methanol (for example, about 5% methanol in water) are typically used as the fuel streams in liquid feed DMFCs.

The polymer electrolyte membrane (PEM) is a solid, organic polymer, usually polyperfluorosulfonic acid, that comprises the inner core of the membrane electrode assembly (MEA). Commercially available polyperfluorosulfonic acids for use as PEM are sold by E.I. DuPont de Nemours & Company under the trademark NAFION®. The PEM must be hydrated to function properly as a proton (hydrogen ion) exchange membrane and as an electrolyte.

For efficient function of the fuel cell, the liquid fuel should be controllably metered or delivered to the anode side. The problem is particularly acute for fuel cells intended to be used in portable applications, such as in consumer electronics and cell phones, where the fuel cell orientation with respect to gravitational forces will vary. Traditional fuel tanks with an outlet at the bottom of a reservoir, and which rely on gravity feed, will cease to deliver fuel when the tank orientation changes.

In addition, dipping tube delivery of a liquid fuel within a reservoir varies depending upon the orientation of the tube within the reservoir and the amount of fuel remaining in the reservoir. Referring to FIG. 1, a cartridge 10 holds a liquid fuel mixture 12 therein. An outlet tube 14 and an air inlet tube 16 protrude from the cartridge cover 18. If the cartridge 10 stably remained at this orientation, the fuel mixture could be drawn out from the outlet tube 14 by pumping action, and the volume space taken by the fuel exiting the cartridge 10 filled by air entering through the air inlet tube 16. However, if the cartridge 10 were tipped on its side, the fuel mixture could be drawn out only so long as the fuel level is above the fuel removal point of the outlet tube.

Accordingly, to facilitate use of liquid fuel cells in portable electronic devices, a liquid fuel reservoir that controllable holds and delivers fuel to a liquid fuel cell, regardless of orientation, is desired.

### SUMMARY OF THE INVENTION

According to one embodiment of the invention, a fuel delivery system for a liquid fuel cell includes (a) a container defining a volume for holding a liquid fuel for a liquid fuel cell; (b) a reservoir structure positioned within the volume and into which at least a portion of the liquid fuel wicks and from which the liquid fuel may be metered; and (c) an outlet passageway through the container that communicates with the reservoir structure in the volume.

The reservoir structure not only wicks and retains liquids, but permits liquids to be controllably metered out from such structure. The reservoir structure has a geometry having a longest dimension. For a cylindrical shaped reservoir structure, the longest dimension may be either its height or its diameter, depending upon the relative dimensions of the cylinder. For a rectangular box-shaped reservoir structure, the longest dimension may be either its height or its length or its thickness, depending upon the relative dimensions of the box. For other shapes, such as a square box-shaped reservoir, the longest dimension may be the same in multiple directions. The free rise wick height (a measure of capillarity) of the reservoir structure preferably is greater than at least one half of the longest dimension. Most preferably, the free rise wick height is greater than the longest dimension.

The reservoir structure may be made from foams, bundled fibers or nonwoven fibers. Preferably, the reservoir structure is constructed from a material selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

If a polyurethane foam is selected for the reservoir structure, such foam should have a density in the range of 0.5 to 25 pounds per cubic foot, and pore sizes in the range of 10 to 200 pores per linear inch, preferably a density in the range of 0.5 to 15 pounds per cubic foot and pore sizes in the range of 40 to 200 pores per linear inch, most preferably a density in the range of 0.5 to 10 pounds per cubic foot and pore sizes in the range of 75 to 200 pores per linear inch.

If a felted polyurethane foam is selected for the reservoir structure, such as a felted reticulated polyurethane foam, such foam should have a density in the range of 2 to 45 pounds per cubic foot and a compression ratio in the range of 1.1 to 30, preferably a density in the range of 3 to 15 pounds per cubic foot and compression ratio in the range of 1.1 to 20, most preferably a density in the range of 3 to 10 pounds per cubic foot and compression ratio in the range of 2.0 to 15.

A felted foam is produced by applying heat and pressure sufficient to compress the foam to a fraction of its original thickness. For a compression ratio of 30, the foam is compressed to 1/30of its original thickness. For a compression ratio of 2, the foam is compressed to ½of its original thickness.

A reticulated foam is produced by removing the cell windows from the cellular polymer structure, leaving a network of strands and thereby increasing the fluid permeability of the resulting reticulated foam. Foams may be reticulated by in situ, chemical or thermal methods, all as known to those of skill in foam production.

In a particularly preferred embodiment, the reservoir structure is made with a foam with a gradient capillarity, such that the flow of the liquid fuel is directed from one region of the structure to another region of the structure as a result of the differential in capillarity between the two regions. One method for producing a foam with a gradient capillarity is to felt the foam to varying degrees of compression along its length. The direction of capillarity flow of liquid is from a lesser compressed region to a greater compressed region. Alternatively, the reservoir structure may be made of a composite of individual components of foams or other materials with distinctly different capillarities.

A pump communicates with the outlet passageway of the fuel delivery system to pump the liquid fuel out of the container through the outlet passageway. An air inlet having a one-way valve is provided to the container to permit gas flow into the volume of the container.

In a particularly preferred embodiment, the reservoir structure held within the container conforms in shape substantially to the volume within the container.

The container of the fuel delivery system may take various shapes, such as a generally cylindrical cartridge comparable in size and shape to disposable dry cell batteries, or other known battery cartridge shapes. Alternatively, and particularly preferred, the container may form a generally planar thin pouch, packet or envelope having flexible top and bottom faces. The envelope may be formed from one or more sheets of a flexible plastic film or a plastic-coated film that are heat-sealed or ultra-sonic welded together at the side edges of the sheets. Such an envelope container is flexibly bendable when filled with liquid fuel, and the reservoir structure into which at least a portion of the liquid fuel has wicked retains such liquid and permits metering of such liquid when the container is so bent. A removable tape may be supplied to cover the outlet passageway when the envelope container is shipped or stored prior to use.

A further embodiment of the invention is a wicking material for a fuel reservoir for a liquid fuel cell formed from a reservoir structure of foam, bundled fibers or nonwoven fibers. Preferably, the reservoir structure is constructed from a material selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

The reservoir structure made from such wicking material not only wicks and retains liquids, but permits liquids to be controllably metered out from such structure. The free rise wick height (a measure of capillarity) of the reservoir structure preferably is greater than at least one half of the longest dimension. Most preferably, the free rise wick height is greater than the longest dimension.

In a particularly preferred embodiment, the wicking material has a gradient capillarity, such that the flow of the liquid fuel is directed from one region of the material to another region of the material as a result of the differential in capillarity between the two regions. Alternatively, the wicking material may be formed as a composite of individual structures of the same or different materials with distinctly different capillarities.

If a polyurethane foam is selected for the wicking material, such foam should have a density in the range of 0.5 to 25 pounds per cubic foot, and pore sizes in the range of 10 to 200 pores per linear inch, preferably a density in the range of 0.5 to 15 pounds per cubic foot and pore sizes in the range of 40 to 200 pores per linear inch, most preferably a density in the range of 0.5 to 10 pounds per cubic foot and pore sizes in the range of 75 to 200 pores per linear inch.

If a felted polyurethane foam is selected for the wicking material, such as a felted reticulated polyurethane foam, such foam should have a density in the range of 2 to 45 pounds per cubic foot and a compression ratio in the range of 1.1 to 30, preferably a density in the range of 3 to 15 pounds per cubic foot and compression ratio in the range of 1.1 to 20, most preferably 10 a density in the range of 3 to 10 pounds per cubic foot and compression ratio in the range of 2.0 to 15.

### DESCRIPTION OF THE FIGURES

FIG. 1 is a front elevational view partially broken away of a prior art fuel cartridge for a liquid fuel cell;

FIG. 2 is a front elevational view of a liquid fuel delivery system for a fuel cell according to the invention;

FIG. 3 is a right side elevational view partially broken away of the liquid fuel delivery system of FIG. 2;

FIG. 4 is a top plan view of the liquid fuel delivery system of FIGS. 2 and 3;

FIG. 5 is a front elevational view of an alternative liquid fuel delivery system for a fuel cell according to the invention;

FIG. 6 is a right side elevational view partially broken away of the alternative liquid fuel delivery system of FIG. 5;

FIG. 7 is a schematic diagram of a wedge of wicking material prior to felting; and

FIG. 8 is a schematic diagram of the wicking material of FIG. 7 after felting.

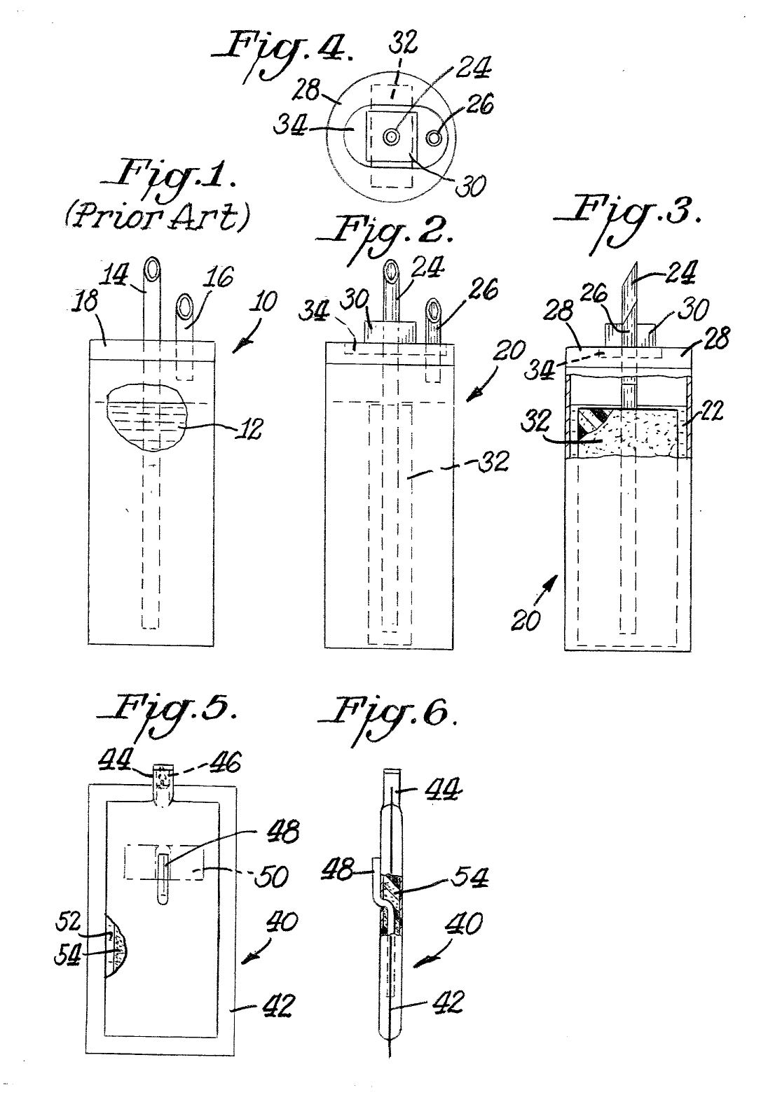

### DESCRIPTION OF THE PREFERRED EMBODIMENTS

Referring first to FIGS. 2 to 4, a cartridge container 20 defines an internal volume holding a liquid fuel mixture 22. An outlet tube 24 extends into the container 20 through a cover 28 and the outlet tube 24 communicates between the internal volume of the container 20 and outside of the container. An air inlet tube 26 also extends into the container 20 through cover 28. The air inlet tube 26 includes a one way valve (not shown) so as to prevent liquid from flowing from the container 20.

A reservoir structure 32 is provided within the volume of the container 20. The reservoir structure 32 surrounds the open end of the outlet tube 24 within the volume of the container 20. Liquid fuel wicks into the reservoir structure 32.

In the embodiment shown in FIGS. 2 to 4, the reservoir structure is a felted polyurethane foam shaped as a rectangular cube or box. The structure is approximately 10 mm (width)×5 mm (thickness)×90 (height) mm, with the 90 mm height as the longest dimension of the structure.

The foam was produced with the following mix:

| Arcol 3020 polyol (from Bayer Corp.) | 100 parts |
|---|---|
| Water | 4.7 |
| Dabco NEM (available from Air Products) | 1.0 |
| A-1 (available for OSi Specialties/Crompton) | 0.1 |
| Dabco T-9 (available from Air Products) | 0.17 |
| L-620 (available from OSi Specialities/Crompton) | 1.3 |

After mixing for 60 seconds and allowed to degas for 30 seconds, 60 parts of toluene diisocyanate were added. This mixture was mixed for 10 seconds and then placed in a 15″×15 ″×5″ box to rise and cure for 24 hours. The resulting foam had a density of 1.4 pounds per cubic foot and a pore size of 85 pores per linear inch. The foam was felted by applying heat (360° F.) and pressure sufficient to compress the foam to ⅕ of its original thickness (i.e., compression ratio=5). The heat and compressive pressure were applied for about 30 minutes. The felted foam had a density of 7.0 pounds per cubic foot.

The container 20 is filled with 6 ml. of an aqueous fuel solution containing 5% methanol. The cover 18 to the container comprises a cap with a rubber serum stopper 34.

A pump 30 acts on the outlet tube 24 and draws liquid fuel 22 from the reservoir structure 32 through the outlet tube 24. Only a slight vacuum needs to be placed on the outlet tube 24 to draw the fuel mixture out of the container. Fuel may be drawn out regardless of the orientation of the container. In one test, with the container in its “vertical” orientation as shown in FIGS. 2 to 4, we were able to draw out 5.0 ml of liquid fuel for a fixed pump setting. In a second test, with the container in an “upside-down” orientation (not shown), we were able to draw out more than 2.0 ml of liquid fuel at the same pump setting. While the “upside-down” orientation causes less efficient fuel delivery, fuel delivery was not interrupted, as would be the case for other fuel delivery systems. Continued development will increase efficiency for all fuel reservoir position orientations.

In an alternate embodiment (not shown), the reservoir structure was selected as a non-woven polyester fiber pad shaped into a rectangular cube or box of approximately 10 mm×5 mm×90 mm. The non-woven pad was formed by mixing together bulk fiber (polyester and melt-binder coated sheathed polyester) and forming the mixture with a combed roller into a layer. The layer was removed from the roller with a moving comb and transferred to a conveyor belt. The conveyor belt fed the material to an articulated arm that stacked multiple layers onto a separate conveyor belt. The multiple layers were heated and compressed to the desired final thickness. Similar fuel delivery was achieved with this non-woven polyester fiber reservoir structure.

In a further alternate embodiment (not shown), the reservoir structure comprised a needled felt. A blend of recycled polyester, polypropylene and nylon fibers were separated and a comb roller pulled a layer of fiber. The layer was removed from the roller with a moving comb and transferred to a conveyor belt. The conveyor belt fed the material to an articulated arm that stacked multiple layers onto a separate conveyor belt. The multiple layers (with a combined thickness of about 10 inches) were fed through two needling operations in which a bank of barbed needles compact the multiple layers together. Needling also forced some fibers to be pulled through the sample to entangle and hold the final shape of the needled felt together. Similar fuel delivery was achieved with a reservoir structure formed as a rectangular cube of the needled felt.

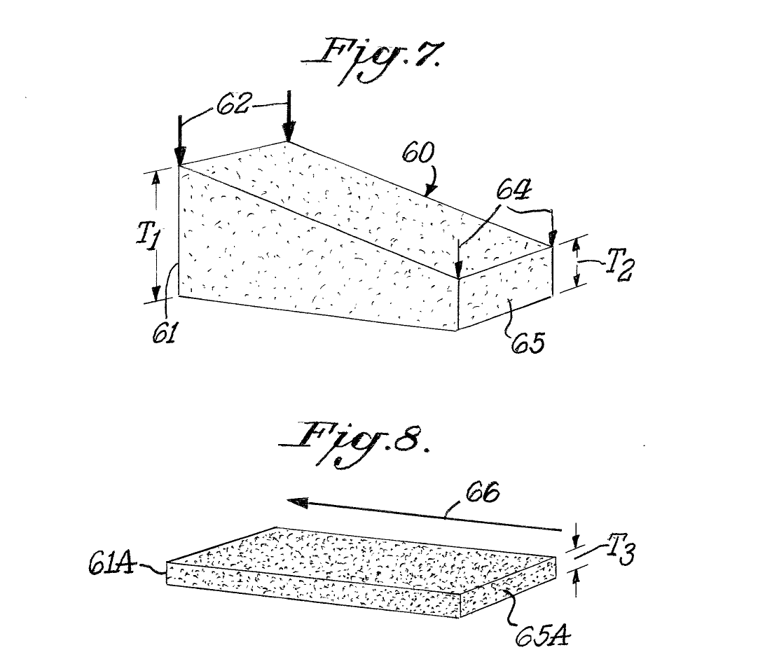

Referring next to FIGS. 5 and 6, an alternate container of flexible packaging for a fuel delivery system is shown. The flexible fuel delivery pouch, packet or envelope 40 comprises one or more sheets connected together to form the pouch, packet or envelope with sealed edges 42. Preferably, the sheets are connected by heat-sealing or ultra-sonic welding. The envelope 40 defines a central volume forming a reservoir for a liquid fuel 52 for a fuel cell. An air inlet 44 is provided with a one way valve 46 to prevent liquid fuel from draining from the envelope 40. The air inlet 44 provides a passageway for air to enter the volume of the envelope as liquid fuel is drawn therefrom.

An outlet tube 48 is provided through the envelope 40. The outlet tube is in fluid communication between the interior volume of the envelope and the fuel cell. Prior to use, the outlet tube 48 may be covered with a covering tape 50, which is shown in phantom outline in FIG. 5. The tape covers the opening of the outlet tube 48. In this way, a pre-filled fuel delivery system may be shipped and stored without leakage of liquid fuel therefrom. The tape 50 is removed when the envelope is installed for use to fuel a fuel cell.

A reservoir structure 54 formed from materials noted above with respect to the embodiment in FIGS. 2 to 4, is held within the volume of the envelope 40. Just as with the first embodiment, a pump (not shown in FIGS. 5 and 6) is used to draw liquid fuel from the interior volume of the container through the outlet tube 48. And like the first embodiment, efficient fuel delivery is independent of the orientation of the envelope and the reservoir structure with relation to gravitational forces.

Preferably, the reservoir structure 54 conforms in dimension to the interior volume of the envelope 40. Because the reservoir structure 54 preferably is flexible, and the envelope 40 preferably is formed from flexible film materials, the entire fuel cell delivery system may be bent or flexed for various positions and configurations when in use. Moreover, the envelope 40 in this preferred embodiment lightweight and formed with substantially planar top and bottom surfaces.

In a particularly preferred embodiment, the reservoir structure is made with a foam with a gradient capillarity, such that the flow of the liquid fuel is directed from one region of the structure to another region of the structure as a result of the differential in capillarity between the two regions. One method for producing a material with a gradient capillarity is to felt a foam to varying degrees of compression along its length. Another method for producing a material with a gradient capillarity is to assemble a composite of individual components with distinctly different capillarities. The direction of capillarity flow of liquid is from a lower capillarity region to a higher capillarity region.

FIGS. 7 and 8 illustrate schematically the method for making a wicking material, such as foam, with gradient capillarity. As shown in FIG. 7, a wedge-shaped slab 60 of foam of consistent density and pore size has a first thickness T1 at a first end 61 and a second thickness T2 at a second end 65. The slab 60 is subjected to a felting step—high temperature compression for a desired time to compress the slab 60 to a consistent thickness T3, which is less than the thicknesses T1 and T2. A greater compressive force, represented by arrows 62, is required to compress the material from T1 to T3 at the first end 61 than is the compressive force, represented by arrows 64 required to compress the material from T2 to T3 at the second end 65.

The compression ratio of the foam material varies along the length of the felted foam shown in FIG. 8, with the greatest compression at the first end 61A (T1 to T3) as compared with the second end 65A (T2 to T3). The capillary pressure is inversely proportional to the effective capillary radius, and the effective capillary radius decreases with increasing firmness or compression. Arrow 66 in FIG. 8 represents the direction of capillary flow from the region of lower felt firmness or capillarity to higher felt firmness or capillarity. Thus, if a wicking material or reservoir structure is formed with a material or composite material having a gradient capillarity, the liquid fuel wicked into the material may be directed to flow from one region of the material with lower compression ratio to another region with higher compression ratio.

The invention has been illustrated by detailed description and examples of the preferred embodiments. Various changes in form and detail will be within the skill of persons skilled in the art. Therefore, the invention must be measured by the claims and not by the description of the examples or the preferred embodiments.

We claim:

1. A fuel delivery system for a liquid fuel cell, comprising:
a container defining a volume for holding a liquid fuel for a liquid fuel cell;
a reservoir structure positioned within the volume and into which at least a portion of the liquid fuel wicks and from which said liquid fuel subsequently may be metered; and
an outlet passageway through the container that communicates with the reservoir structure in the volume.

2. The fuel delivery system of claim 1, wherein the reservoir structure has a longest dimension and the free rise wick height of the reservoir structure is greater than at least one half of the longest dimension.

3. The fuel delivery system of claim 1, wherein the reservoir structure has a longest dimension and the free rise wick height of the reservoir structure is greater than the longest dimension.

4. The fuel delivery system of claim 2, wherein the reservoir structure is formed from a material selected from the group consisting of foam, bundled fiber and nonwoven fiber.

5. The fuel delivery system of claim 4, wherein the material is selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

6. The fuel delivery system of claim 4, wherein the reservoir structure comprises polyurethane foam with a density in the range of 0.5 to 25 pounds per cubic foot and pore sizes in the range of 10 to 200 pores per linear inch.

7. The fuel delivery system of claim 4, wherein the reservoir structure comprises polyurethane foam with a density in the range of 0.5 to 15 pounds per cubic foot and pore sizes in the range of 40 to 200 pores per linear inch.

8. The fuel delivery system of claim 4, wherein the reservoir structure is a felted reticulated polyurethane foam with a density in the range of 2 to 45 pounds per cubic foot and compression ratio in the range of 1.1 to 30.

9. The fuel delivery system of claim 1, wherein the reservoir structure has a gradient capillarity.

10. The fuel delivery system of claim 1, wherein the reservoir structure is formed as a composite of two or more components, wherein at least two of such components have different capillarities.

11. The fuel delivery system of claim 1, further comprising:
a pump in communication with the outlet passageway to pump liquid fuel out of the container through the outlet passageway.

12. The fuel delivery system of claim 1, further comprising:
an air inlet through the container, said air inlet having a one-way valve to permit gas flow into the volume of the container.

13. The fuel delivery system of claim 1, wherein the reservoir structure conforms in shape substantially to the volume within the container.

14. The fuel delivery system of claim 1, wherein the container forms a generally cylindrical cartridge.

15. The fuel delivery system of claim 1, wherein the container has flexible sidewalls.

16. The fuel delivery system of claim 15, wherein the container comprises an envelope formed from one or more sheets of a plastic film or a plastic-coated film.

17. The fuel delivery system of claim 16, further comprising a removable tape that covers the outlet passageway when the container is shipped or stored prior to use.

18. The fuel delivery system of claim 1, wherein the container is flexibly bendable when filled with liquid fuel and the reservoir structure into which at least a portion of the liquid fuel has wicked remains within the volume of the container.

19. A wicking material for a fuel reservoir for a liquid fuel cell, comprising:
a material selected from the group consisting of foam, bundled fiber and nonwoven fiber.

20. The wicking material of claim 19, wherein the material is selected from the group consisting of polyurethane foam, felted polyurethane foam, reticulated polyurethane foam, felted reticulated polyurethane foam, melamine foam, nonwoven felts or bundles of nylon, polypropylene, polyester, cellulose, polyethylene terephthalate, polyethylene, polypropylene and polyacrylonitrile, and mixtures thereof.

21. The wicking material of claim 19, wherein the wicking material forms a reservoir structure having a longest dimension and the free rise wick height of the reservoir structure is greater than at least one half of the longest dimension.

22. The wicking material of claim 19, wherein the wicking material forms a reservoir structure having a longest dimension and the free rise wick height of the reservoir structure is greater than the longest dimension.

23. The wicking material of claim 19, wherein the wicking material comprises polyurethane foam with a density in the range of 0.5 to 25 pounds per cubic foot and pore sizes in the range of 10 to 200 pores per linear inch.

24. The wicking material of claim 19, wherein the wicking material comprises polyurethane foam with a density in the range of 0.5 to 15 pounds per cubic foot and pore sizes in the range of 40 to 200 pores per linear inch.

25. The wicking material of claim 19, wherein the wicking material comprises a felted reticulated polyurethane foam with a density in the range of 0.5 to 45 pounds per cubic foot and a compression ratio in the range of 1.1 to 30.

26. The wicking material of claim 19, wherein the wicking material forms a reservoir structure and said structure has substantially planar top and bottom faces.

27. The wicking material of claim 19, wherein the wicking material has a gradient capillarity.

28. The wicking material of claim 27, wherein the wicking material is formed from felted foam.

29. The wicking material of claim 27, wherein the wicking material is formed as a composite of two or more components and wherein at least two of such components have different capillarities.

30. The wicking material of claim 29, wherein a first component of the composite has a higher capillarity than a second component of the composite, and said first component has a longest dimension, and the free rise wick height of the first component is greater than one half of the longest dimension.

31. The wicking material of claim 29, wherein a first component of the composite has a higher capillarity than a second component of the composite, and said first component has a longest dimension, and the free rise wick height of the first component is greater than the longest dimension.

32. A package for a fuel reservoir for a liquid fuel cell, comprising:
an envelope defining a volume for holding a liquid fuel for a liquid fuel cell, said envelope formed from one or more sheets of a plastic film or a plastic-coated film;
a reservoir structure positioned within the volume and into which at least a portion of the liquid fuel wicks; and
an outlet passageway through the container that communicates with the reservoir structure in the volume.

33. The package of claim 32, further comprising a removable tape that covers the outlet passageway when the package is shipped or stored prior to use.

34. The package of claim 32, wherein the package is flexibly bendable when filled with liquid fuel and the reservoir structure into which at least a portion of the liquid fuel has wicked remains within the volume of the package.

35. The package of claim 32, wherein the envelope has a first face and a second face and said first and second faces are substantially planar.

36. The package of claim 32, wherein the envelope is a pouch formed by heat-sealing or ultra-sonic welding.

37. The package of claim 32, wherein the reservoir structure is a wicking material with gradient capillarity.

38. The package of claim 37, wherein the wicking material is formed as a composite of two or more components and wherein at least two of such components have different capillarities.

39. The package of claim 38, wherein a first component of the composite has a higher capillarity than a second component of the composite, and said first component has a longest dimension, and the free rise wick height of the first component is greater than one half of the longest dimension.

40. The wicking material of claim 38, wherein a first component of the composite has a higher capillarity than a second component of the composite, and said first component has a longest dimension, and the free rise wick height of the first component is greater than the longest dimension.
